(19) United States
(12) Patent Application Publication
(10) Pub. No.: US 2025/0296777 A1
(43) Pub. Date: Sep. 25, 2025

(54) MODULAR DISPENSING SYSTEM AND METHODS

(71) Applicant: Romaine Empire, Inc., Chicago, IL (US)

(72) Inventors: Luke Saunders, Chicago, IL (US); Brian Schoolcraft, Cedar Park, TX (US); Robert Butler, Liberty Hill, TX (US)

(21) Appl. No.: 19/086,984

(22) Filed: Mar. 21, 2025

Related U.S. Application Data
(60) Provisional application No. 63/568,621, filed on Mar. 22, 2024.

(51) Int. Cl. B65G 1/137; G07F 11/00

(52) U.S. Cl. CPC B65G 1/1371; G07F 11/007; B65G 2203/0283; B65G 2203/041

(57) ABSTRACT

A modular dispensing system for a vending machine. The system includes a grid of mounting rails, each mounting rail having at least one X/Y position on the grid, and a plurality of dispensing modules removably coupled to the mounting rails of the grid, at least one dispensing module configured to receive an item for purchase. Each dispensing module of the plurality of dispensing modules is configured to be coupled to more than one mounting rail of the grid at multiple X/Y positions of the grid of mounting rails to accommodate one or more heights of the item for purchase.

### CROSS-REFERENCE TO RELATED APPLICATIONS

This application claims the benefit of and priority to U.S. Application 63/568,621filed on Mar. 22, 2024, the entire disclosure of which is hereby incorporated by reference.

### FIELD OF THE DISCLOSURE

The present disclosure generally relates to systems, methods, and apparatuses related to a modular vending machine, and, more particularly, to control of a plurality of modular dispensing modules upon which items offered for sale are placed.

### BACKGROUND

Vending machines typically include a plurality of dispensing modules via which items offered for sale are placed and dispensed upon command. Conventionally, the dispensing modules are pre-configured in a fixed arrangement prior to deployment at a customer site. For example, dispensing modules are typically screwed in or otherwise fixedly attached to the base vending machine unit.

Customer demand for items offered for sale at a vending machine and the products offered for sale by vending machine operators changes over time. Thus, the particular items offered for sale at a given vending machine needs to adapt in response to these changes. However, because traditional dispensing modules are affixed to the base vending machine unit, operators of conventional vending machines are unable to rearrange and/or replace the dispensing modules over time. As a result, if there is a need for a vending machine to, for example, be stocked with additional large items, there may be insufficient slots in the pre-configured arrangement of dispensing modules. Similarly, the dispensing modules for larger items may be located in positions associated with lower customer engagement than the dispensing modules for smaller items. Thus, conventional vending machine operators are also unable to reconfigure the dispensing modules to more optimally place the dispensing modules for larger items. In view of the foregoing challenges, there is a need for a vending machine that supports a modular configuration of dispensing modules.

In some prior attempts to provide a modular arrangement of dispensing modules, dispensing modules could be modularly rearranged within a tray that holds a plurality of dispensing modules to support the weight of the individual dispensing modules. While this enables some modularity within a row of items offered for sale, the use of a tray limits the ability to offset a vertical position of the dispensing modules to account for the height of items offered for sale. To this end, even if there is an empty position in a row between two dispensing modules, the presence of the tray prevents the placement of a taller item in the row below the empty position. In other words, the need to support the weight of the individual dispensing modules and the items placed thereon still limited the ability of operators to modularly configure a vending machine.

In addition, other existing modular arrangements of dispensing modules work well when items to be placed on the dispensing modules are about the size of each modular mounting location, for example. This allows many items to be placed within the vending machine and helps minimize unused spaced within the vending machine. However, when items to be placed within the vending machine are larger and/or a different size than the mounting location, the items placed on the dispensing module of the vending machine then often cover and/or overlap other surrounding mounting locations and/or spaces. As a result, additional dispensing modules are prevented from being coupled to the other surrounding mounting locations, wasting space within the vending machines for items to be offered for sale and not maximizing the capacity of the vending machine.

Further, by improving the modularity of the dispensing modules, vending machine operators may be able to quickly reconfigure the arrangement of dispensing modules during a restocking event. However, when the configuration of the dispensing modules changes during a restocking event, there is an increased likelihood that items are restocked on the incorrect dispensing module. For example, if an item is to be placed on a newly-positioned dispensing module, the serviceperson may be inclined to mistakenly place the item on a dispensing module that already includes items of the same item type.

### SUMMARY

In one example, a vending machine comprises a housing; and a modular dispensing system disposed within the housing. The modular dispensing system comprises a grid of mounting rails, each mounting rail having at least one X/Y position on the grid, and a plurality of dispensing modules removably coupled to the mounting rails of the grid, at least one dispensing module configured to receive an item for purchase. Each dispensing module of the plurality of dispensing modules is configured to be coupled to more than one mounting rail of the grid at multiple X/Y positions of the grid of mounting rails to accommodate one or more heights of the item for purchase.

In another example, a method of coupling a dispensing module of a modular dispensing system for a vending machine to more than one mounting rail of the modular dispensing system, where the modular dispensing system includes a grid of mounting rails and a plurality of dispensing modules, comprises latching an arm disposed at one end of at least one dispensing module to a mounting lip of a first mounting rail. The method also comprises moving, via an actuator, a clamp disposed at another end of the at least one dispensing module into contact with a mounting lip of a second mounting rail to couple the dispensing module to the first and second mounting rails, such that the body of the dispensing module is disposed approximately perpendicular to a longitudinal axis of a grid of mounting rails.

In yet another example, a modular dispensing system for a vending machine comprises a grid of mounting rails, each mounting rail having at least one X/Y position on the grid, and a plurality of dispensing modules removably coupled to the mounting rails of the grid. At least one dispensing module is configured to receive an item for purchase. In addition, each dispensing module of the plurality of dispensing modules is configured to be coupled to more than one mounting rail of the grid at multiple X/Y positions of the grid of mounting rails to accommodate one or more heights of the item for purchase.

In still another example, a method of coupling a dispensing module of a modular dispensing system for a vending machine to more than one mounting rail of the modular dispensing system comprises latching an arm disposed at one end of at least one dispensing module to a mounting lip of a mounting rail. The method also comprises moving, via an actuator, a clamp disposed at another end of the at least one dispensing module into contact with a mounting lip of another mounting rail to couple the dispensing module to the mounting rails, such that the body of the dispensing module is disposed approximately perpendicular to a longitudinal axis of a grid of mounting rails. The method still also comprises identifying, via at least one of at least one processor of the vending machine or a camera disposed in the housing of the vending machine, at least one X/Y position of the dispensing module based on at least one X/Y position of the mounting rails of the grid to which the dispensing module is coupled.

In a further example, a method of registering a dispensing module of a modular dispensing system for a vending machine is provided. The modular dispensing system includes a grid of mounting rails. The method comprises detecting, by a vending machine controller, an identifier associated with the dispensing module and analyzing, by the vending machine controller, image data of the dispensing module to determine an X/Y position of the dispensing module. The method also comprises updating, by the vending machine controller, a registry to include an association between the identifier of the dispensing module and the X/Y position of the dispensing module.

### BRIEF DESCRIPTION OF THE FIGURES

FIG. 1 illustrates an example vending machine of the present disclosure;

FIG. 2A is a block diagram of an example vending machine, such as the vending machine of FIG. 1;

FIG. 2B is a block diagram of an example dispensing module to be received at the vending machine of FIG. 1;

FIG. 3A is a perspective view of a portion of the vending machine of FIG. 1, with a door in an open position;

FIG. 3B is close-up view of a camera of the vending machine of FIG. 3;

FIG. 4A is a configuration of the vending machine of FIG. 2A that registers dispensing modules by activating dispensing module indicator units;

FIG. 4B is a configuration of the vending machine of FIG. 2A that registers dispensing modules by detect codes associated with dispensing modules;

FIG. 5 is a perspective view of a portion of a modular dispensing system of the vending machine of FIGS. 1 and 3 having a custom configuration of dispensing modules for accommodating units of product of the vending machine;

FIG. 6 is a perspective view of another portion of the modular dispensing system of FIGS. 1 and 3 having another custom configuration of dispensing modules;

FIG. 7A is a front view of a grid of mounting rails of the modular dispensing system of FIGS. 1 and 3;

FIG. 7B is a portion of the grid of the mounting rails of FIG. 7A with dispensing modules coupled to the grid;

FIG. 7C is a portion of the grid of mounting rails of FIG. 7A depicting a conductive strip with an electrical connection of a dispensing module coupled to the conductive strip;

FIG. 8 is a rear perspective view of a dispensing module of the modular dispensing system;

FIG. 9 is a front perspective view of the dispensing module of the modular dispensing system of the present disclosure;

FIG. 10 is a rear view of the dispensing module of FIG. 8;

FIG. 11 is a side view of the dispensing module in an unlatched position relative to the mounting rails of the grid;

FIG. 12 is a side view of the dispensing module in a latched position relative to the mounting rails of the grid;

FIG. 13 is a front perspective view of another dispensing module that may be used with the modular dispensing system of FIGS. 1 and 3;

FIG. 14 is a side-by-side view of the dispensing module of FIG. 13 and the dispending module of FIG. 8;

FIG. 15 is a rear view of the dispensing module of FIG. 13;

FIG. 16 is a side view of the dispensing module of FIG. 13 in a latched position relative to the mounting rails of the modular dispensing system;

FIG. 17 is a close-up view of a portion of the dispensing module of FIG. 16, depicting an end portion of the dispensing module of FIG. 16 in the latched position relative to the mounting rails of the grid of the modular dispensing system of the present disclosure; and

FIG. 18 is an example method of registering a dispensing module of a modular dispensing system.

### DETAILED DESCRIPTION

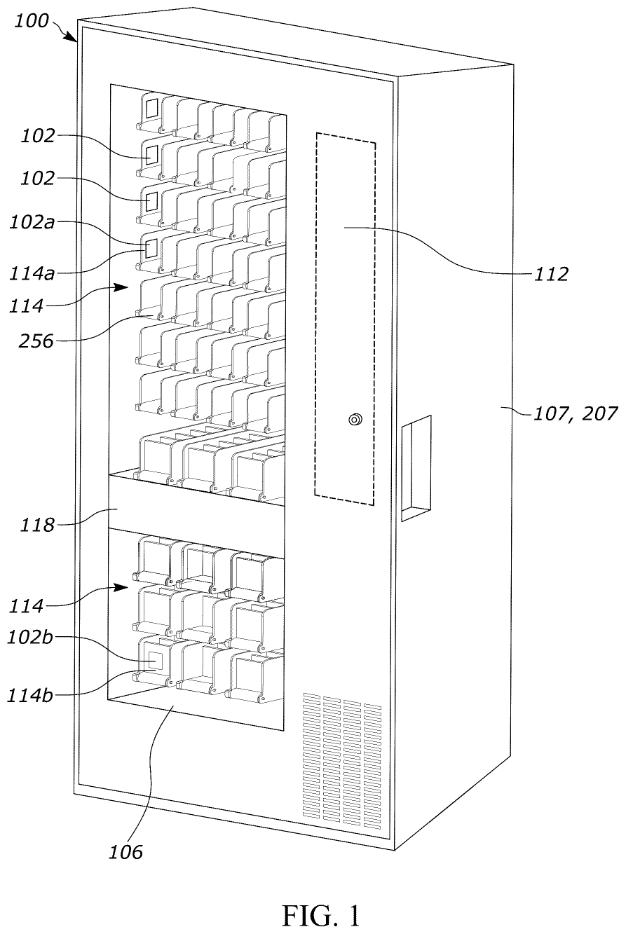

Referring to the figures in detail, FIG. 1 illustrates an example vending machine 100 in which the present techniques are implemented. The vending machine 100 may be a self-service unit that combines electro-mechanical dispensing components, temperature control components, network connectivity, and a user interface for customer interaction. The vending machine 100 may include any suitable type of vending machine 100. For example, the vending machines 100 may include a storage system for holding individual items 102 for purchase. In one example, the storage system includes a modular dispensing system, as explained more below. More particularly, the modular dispensing system may include a plurality of dispensing modules 114 in which the individual items 102 are loaded. The dispensing modules 114 may be substantially horizontal, such as embodiments that include a conveyor belt, shelf, or coil, as explained more below. Additionally, the dispensing modules 114 may include an indicator unit 256 (e.g., a light emitting diode (LED) or a display unit). In the illustrated example, the vending machine 100 includes a gantry 118 to receive the items 102 dispensed by the dispensing module 114 and carry the received items 102 to a dispensing slot 106. The customer may then take the items 102 from the dispensing slot 106.

The vending machine 100 may also include an atmospheric control system that includes a variety of sensors and controllers for temperature, air composition, and/or humidity control. The temperature control components may include a cooling or refrigerating apparatus, a heating or warming apparatus, and/or other temperature control apparatuses to maintain a desired temperature associated with the items stored therein. For example, some fresh foods are best stored between 35-40° F. (1.66-4.44° C.). In some embodiments, the vending machine 100 includes different temperature control apparatuses to regulate the temperature of different slots. A temperature control apparatus may include one or more sensors to provide feedback to a regulator of the temperature control apparatus.

The vending machine 100 may also include a point of sale system. In some embodiments, the point of sale system includes one or more mechanisms to receive a customer selection of a particular item 102. For example, the selection mechanisms may include one or more buttons and/or touchscreen displays. In the illustrated example, the vending machine 100 includes a stationary primary display unit 112. The vending machine 100 may control both the position of the gantry 118 and the stationary primary display unit 112 to assist the customer selection of the items 102. For example, if the customer selects an indication of a particular item 102 via the primary display unit 112, the vending machine 100 may position the gantry 118 proximate to the dispensing module 114 in which the item 102 is loaded. To this end, the vending machine 100 may position the gantry 118 above, below, to the side, or even in front of the particular item 102. If the customer does complete a purchase for particular item 102, the gantry 118 is already positioned proximate to the corresponding dispensing module 114, reducing the overall amount of time required to vend the particular item 102.

In some embodiments, the inventory control system of the vending machine 100 is configured to dynamically monitor inventory within the particular vending machine 100. In one example, the inventory control system of the vending machine 100 synchronizes inventory data with a management server to maintain a central record of the inventory. In this example, the inventory update may include a sale record associated with the change in inventory. When an item is purchased, the inventory control system detects corresponding sensor data that indicates that the item is no longer within the vending machine 100. According to aspects, the transaction data may also include customer data such as demographic data, customer profile information, addressing information (including an identity and/or address of a customer electronic device), and so on.

Additionally, the inventory control system of the vending machine 100 may include a planogram that indicates the arrangement of the dispensing modules 114 and their correspondence to the items 102. As will be explained in more detail below, the vending machine 100 may include a grid of mounting rails configured to removably receive the dispensing modules 114. Accordingly, the planogram may indicate a correspondence between the dispensing modules 114 with the mounting rails. In some arrangements, the planogram may indicate that a particular mounting rail is not to receive a dispensing module 114 (e.g., when the planogram indicates that a mounting rail immediately below the particular mounting rail is to receive a dispensing module 114). Additionally, the planogram indicates which items 102 are to be loaded into the dispensing modules 114. For example, the planogram may indicate that the item 102a is to be loaded into the dispensing module 114a and the item 102b is to be loaded into the dispensing module 114b. For items 102 that are particularly wide, the planogram may indicate that the item 102 is to be loaded across multiple dispensing modules 114.

The vending machine 100 may be in communication with a management server (not depicted) via one or more communication networks. The communication networks may facilitate any type of data communication via any current or future-developed standard or technology (e.g., GSM, CDMA, TDMA, WCDMA, NR, LTE, EDGE, OFDM, GPRS, EV-DO, UWB, IEEE 802 including Ethernet and Wi-Fi, WiMAX, Bluetooth, RS-232 serial communications, and others). The vending machine 100 may be configured to receive planogram update indications from the management server via the communication networks. The planogram update may indicate a new planogram for the vending machine 100. Accordingly, a serviceperson may be instructed to rearrange the dispensing modules 114 and/or the items 102 to comply with the new planogram indicated by the planogram update. This process will be described in more detail below.

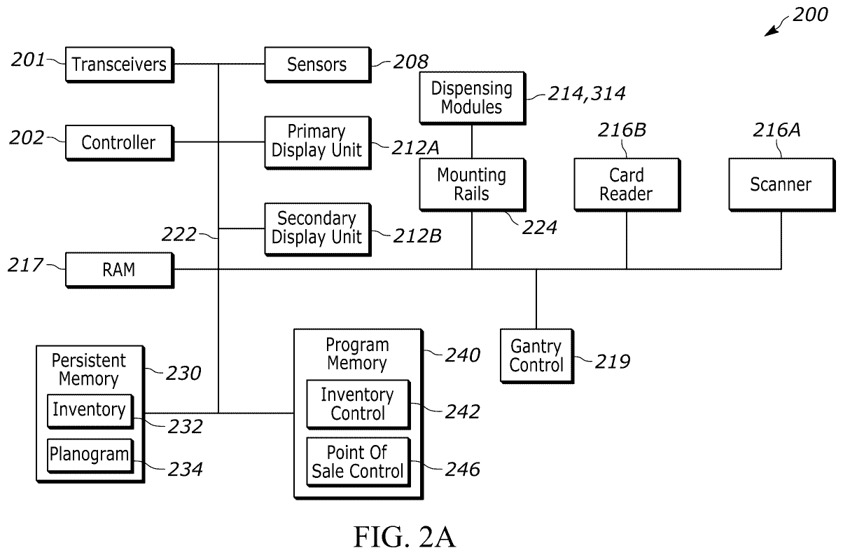

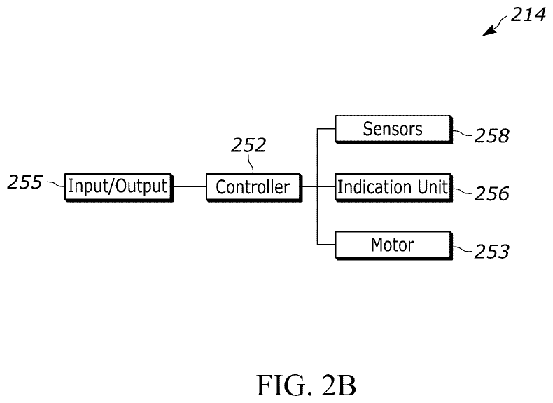

Turning to FIG. 2A, illustrated is an example vending machine 200, such as the vending machine 100 of FIG. 1, at which functionality described herein is implemented. The vending machine 200 may include transceivers 201 that enable the vending machine 200 to exchange data over a wireless or wired network with, for example, a management server. The transceivers 201 may include one or more transceivers (e.g., WWAN, WLAN, WPAN, EVDO, CDMA, GSM and/or LTE transceivers) functioning in accordance with IEEE standards, 3GPP standards, or other standards.

The vending machine 200 includes a controller 202 that includes one or more processors and/or controllers, such as a central processing unit (CPU) 202, a graphics processing unit (GPU), a programmable logic controller (PLC), a proportional-integral-derivative (PID) controller, etc. During operation, the controller 202 executes instructions stored in a program memory module 240 coupled to the controller 202 via a system bus 222. In some implementations, the program memory module 240 is implemented in a random access memory (RAM) module 217, a persistent memory module 230, or both. The program memory module 240 may also store computer-readable instructions that regulate the operation of the vending machine 200. Accordingly, the controller 202 (in coordination with the controllers 252 of the dispensing modules 214) may be configured to execute one or more of the flowcharts described herein.

As illustrated, the vending machine 200 also includes mounting rails 224 configured to removably receive dispensing modules 214 (such as the dispensing modules 114 as described with respect to FIG. 1). With simultaneous reference to FIG. 2B, illustrated is an example dispensing module 214. It should be appreciated that the vending machine 200 may include any number of dispensing modules 214 configured in the manner described with respect to FIG. 2B.

The dispensing modules 214 includes a controller 252 configured to control operation of the dispensing module 214. The controller 252 may include a processor such as, for example, one or more microprocessors, controllers, and/or any suitable type of processor and a memory storing instructions that are executed by the processors to perform the functionality of the dispensing module 214 described herein. The controller 252 is communicatively coupled to the controller 202 of the vending machine 200 via an I/O interface 255. The I/O interface 255 may include one or more transceivers configured in accordance with a communication protocol for communications between the dispensing modules 214 and the vending machine 200. As will be described in more detail below, the communication link between the controller 252 and the controller 202 may be completed when the dispensing module 214 is securely received into a mounting rail 224.

The dispensing module 214 includes a motor 253 that drives a dispensing mechanism of the dispensing module 214. For example, the motor 253 may be configured to drive a conveyor belt, a coil, a plunger, or any other dispensing mechanism known in the art. The motor 253 may be able to operate in both a forward mode to move an item loaded into the dispensing module 214 toward the front of the vending machine 200 and a reverse mode to move an item loaded into the dispensing module 214 towards the rear of the vending machine. In some embodiments, the motor 253 includes its own controller configured to interpret instructions received from the controller 252. For example, instead of merely operating in a forward or reverse mode, the motor 253 may be controlled to provide different power outputs resulting in a different rate of motion exhibited by the dispensing mechanism. As will be described in more detail below, some items may be placed across two or more dispensing modules 214. Accordingly, the controller 252 may adjust the power output of the motor 253 to maintain a synchronous dispensing motion with the other dispensing modules 214.

The example dispensing module 214 includes one or more sensors 258 to sense various conditions associated with the dispensing module. For example, the sensors 258 may include one or more sensors configured to detect when an item has been loaded into the front of the dispensing module 214. In this example, the sensors 258 may include a weight sensor disposed in a front end of the dispensing module 214 or a pressure sensor proximate to a weight-bearing mechanism at the base of the dispensing module 214. As another example, the sensors 258 may include one or more sensors configured to monitor operation of the motor 253 and/or the dispensing mechanism controlled by the motor 253. As yet other examples, the sensors 258 may include a beam break sensor having a beam oriented towards positions on the dispensing module 214 or an image sensor configured to capture image data of a code (e.g., bar code or QR code) disposed on an item placed on the dispensing unit 214. In some embodiments, the beam break sensors and/or the image sensor are configured to monitor multiple dispensing units and are included in the vending machine 200 in positions external to the dispensing module 214.

As illustrated, the dispensing module 214 includes the indication unit 256, such as one or more light emitting diodes (LEDs), a display screen, or other types of configurable output devices. The controller 252 may be configured to interface with the indication unit 256 to provide indications to individuals interacting with the vending machine 200. For example, when a serviceperson is restocking the vending machine 200, the controller 252 may configure the indication unit to provide a first response to indicate that an item is to be loaded into the dispensing module 214 (e.g., illuminate the LEDs in a green color). As another example, if the serviceperson incorrectly loaded an item into the dispensing module 214, the controller 252 may configure the indication unit to provide a second response to indicate the incorrect action (e.g., illuminating the LEDs in a red color and/or causing the LEDs to blink).

In operation, the controller 252 is configured to receive instructions for controlling the motor 253 and/or the indication unit 256 from the controller 202 via the I/O 255 For example, the application being executed by the controller 202 may instruct the controller 252 to control operation of the motor 253 in a particular manner. In response, the controller 252 may transmit an acknowledgement message back to the controller 202 via the I/O 255. The controller 252 may also be configured to transmit reports based on sensor data generated by the sensors 258 to the controller 202. For example, controller 252 may be configured to detect that the sensors 258 indicate that an item was loaded into the dispensing module 214 and transmit a report to the controller 202 for analysis thereat.

Returning to FIG. 2A, one set of instructions stored in the memory 240 may be an inventory control application 242 that contains instructions to facilitate inventory control functionality. For example, the inventory control application 242 may maintain an accurate record of the various items stored at the vending machine 200. This record may be maintained at the inventory database 232 of the persistent memory 230. The records in the inventory database 232 may include indications of an item identifier, a stock keeping unit (SKU) identifier, a location (such as a dispensing module identifier), expiration data, an item status (e.g., available, reserved, expired, locked, sold, etc.), and so on. In some embodiments, the inventory database 232 also includes SKU-based records that include indications of SKU quantity, a cost, SKU status (e.g., normal, recalled, promoted, stocked out, etc.). The SKU-based records may be automatically updated in response to changes to item records. For example, when the inventory control application 242 updates an item record to indicate that a particular item has been sold and/or reserved, the SKU-record may automatically decrement a quantity parameter.

The inventory control application 242 may also be configured to store and/or update a planogram 234 that indicates an arrangement of dispenser modules 214 with respect to a plurality of mounting rails 224 and an arrangement of items (such as the items 102 as described with respect to FIG. 1) with respect to the dispensing modules 214. In one implementation, the planogram 234 includes a grid of mounting objects that reflects the arrangement of the mounting rails 224. Mounting objects in the planogram 234 may correspond to a dispensing object that indicates a type of dispensing module 214. Similarly, dispensing objects in the planogram 234 may correspond to item objects that indicate an item type for items to be loaded into the corresponding dispensing module 214.

As illustrated, applications in the program memory 240 are configured to communicate with a particular dispensing module 214 via the particular mounting rail 224 at which the particular dispensing module 214 is received. Accordingly, the inventory control application 242 may update the planogram 234 with information related to the correspondence between the mounting rails 224 and the dispensing modules 214. In one example technique to determine the correspondence, the mounting rails 224 are configured with circuitry that completes a circuit when a dispensing module 214 is properly received thereat. In response, the mounting rail 224 may indicate to the inventory control application 242 that a dispensing module 214 has been received thereat. The inventory control application 242 reply to the mounting rail 224 with a “wake up” instruction configured to cause the controller 252 of the dispensing module 214 received thereat to respond with identity information (e.g., a dispenser type, a dispenser identifier, etc.). The inventory control application 242 may then update the dispenser object corresponding to the mounting rail 224 in the planogram 234 to include the received identity information.

The inventory control application 242 may reference the identity information in the planogram 234 to control the corresponding dispensing module 214. For example, the inventory control application 242 may be configured to actuate the motor 253 of the dispensing module 214 in a forward direction to unload an item (e.g., in response to a customer purchase or to unload the dispensing module 214 during a restocking event). As another example, the inventory control application 242 may be configured to actuate the motor 253 in a reverse direction to move a restocked item further back into the vending machine 200 such that another item can be loaded into the front of the dispensing module 214.

In some embodiments, each mounting rail 224 is connected to the system bus 222. In these embodiments, to control a particular dispensing module 214, the controller 202 addresses the control instruction to the particular mounting rail 224 which relays the control instruction on to the controller 252 of the particular dispensing module 214. Additionally or alternatively, the mounting rails 224 may be connected to a dispensing module control bus (not depicted) connected to the system bus 222. In these embodiments, the I/O 255 of the dispensing modules 214 are connected to the dispensing module control bus. Accordingly, the controllers 252 of the dispensing modules 214 may monitor the dispensing module control bus for control instructions addressed thereto. Accordingly, in these embodiments, the controller 202 includes an identifier of the dispensing module 214 that is to execute the control instruction and routes the control instruction to the dispensing module control bus.

As illustrated, the example vending machine 200 includes a scanner 216A to scan identifying information associated with items loaded into the vending machine 200. The scanner 216A may be a barcode scanner, a radio frequency identification (RFID) scanner, a near field communication (NFC) scanner, or other type scanner capable of scanning identifying information associated with items. In some embodiments, the scanner 216A is affixed to a housing of the vending machine 200. In other embodiments, the scanner 216A may be a handheld scanner (e.g., a dedicated handheld barcode scanner, user equipment associated with the serviceperson, etc.) coupled to the vending machine 200. Accordingly, while FIG. 2A depicts the scanner 216A as being coupled to the system bus 222, in some embodiments, the scanner 216A is wirelessly coupled to the vending machine 200 via the transceivers 201.

The scanner 216A enables the inventory control application 242 to provide assisted restocking guidance to a serviceperson restocking the vending machine 214. To this end, prior to restocking an item, the serviceperson is instructed to scan the item via the scanner 216A. The inventory control application 242 is configured to detect the item identifier associated with the item to determine an item type for the item. Using the determined item type, the inventory control application 246 queries the planogram 234 to identify a dispensing module 214 in which the item is to be loaded. If there are multiple dispensing modules 214 associated with the item type, the inventory control application 242 may alternate between the dispensing modules 214. Upon identifying the dispensing module 214 in which the item is to be loaded, the inventory control application 242 may instruct the dispensing module 214 to enable the indication unit 256 in a manner that indicates the item is to be loaded into that dispensing module.

The program memory 240 may also include a set of instructions that comprises a point of sale control application 246 configured to support the ordering of items and the processing of payments at the vending machine 200. The point of sale control application 246 may be configured to cause a primary display unit 212A and the secondary display unit 212B to present one or more interfaces that guide a customer through the purchase process. The primary display unit 212A may include a touch-screen display for receiving user input. In some embodiments, the point of sale control application 246 may query the inventory database 236 to populate the interfaces with indications of the available inventory. As part of the payment process, the point of sale control application 246 monitors inputs at a card reader 216B to detect credit card information for completing the purchase.

As part of guiding the customer through the purchase process, the point of sale control application 246 may determine that the customer is viewing a user interface associated with a particular item type offered for sale. In response, the point of sale control application 246 may query the planogram 234 to identify a dispensing module 214 in which items of the particular item type is loaded. To reduce waste, if multiple dispensing modules 214 include items of the particular item type, the point of sale control application 246 may identify the dispensing module 214 with the oldest not-expired item of the particular item type at the front most position. After identifying the dispensing module 214, the point of sale control application 246 may instruct the gantry control 219 to move to a position proximate to the dispensing module 214. Additionally, the point of sale control application 246 may configure the secondary display unit 212B to display additional information regarding items of the particular item type.

It should be appreciated that while the foregoing sets out a description of the inventory control application 242 and the point of sale control application 246, in other embodiments, the functionality described with respect to the inventory control application 242 and the point of sale control application 246 may be divided and/or combined into any number of applications stored in the program memory 240.

In addition to the program memory 240, the RAM module 217 and the persistent memory module 230 may store data in a volatile or non-volatile mode, respectively. The RAM module 217 and the persistent memory module 230 further include one or more forms of fixed and/or removable memory, such as read-only memory (ROM), electronic programmable read-only memory (EPROM), RAM, erasable electronic programmable read-only memory (EEPROM), and/or other hard drives, flash memory, MicroSD cards, and others. For example, the inventory database 232 and the planogram 234 may be stored as data structures in the persistent memory module 230.

It should be appreciated that the vending machine 200 may include additional or fewer components than what is depicted by FIG. 2A. For example, the vending machine 200 may include keys, mice, buttons, or other physical input devices to facilitate user interactions with the vending machine 200. As another example, the vending machine 200 may include one or more external ports or other components that enable service personnel to interact with the vending machine 200, such as a USB or other port via which a service electronic device can be connected to transmit diagnostic messages for troubleshooting and/or maintenance activities. As yet another example, the vending machine 200 may include one or more cameras, scanners, or other sensors connected to track the items stored at the vending machine 200 and/or to support security surveillance, stock monitoring, scanning customer electronic devices, customer biometric recognition, and/or gesture-based reservation pickup, for example.

### Modular Dispensing System

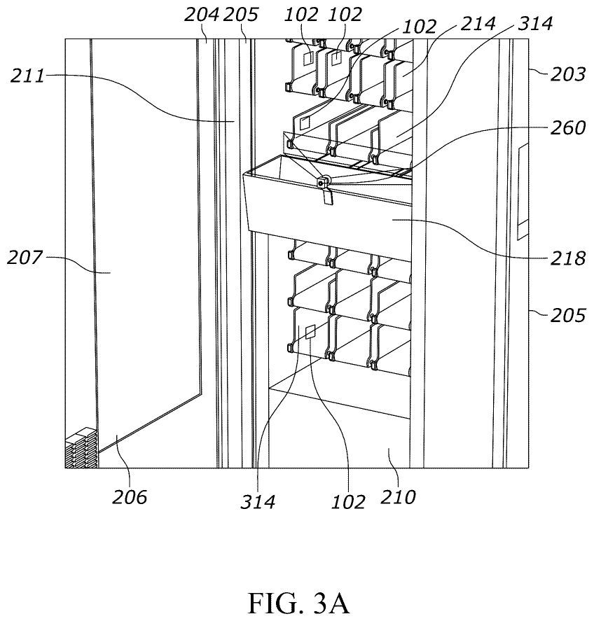

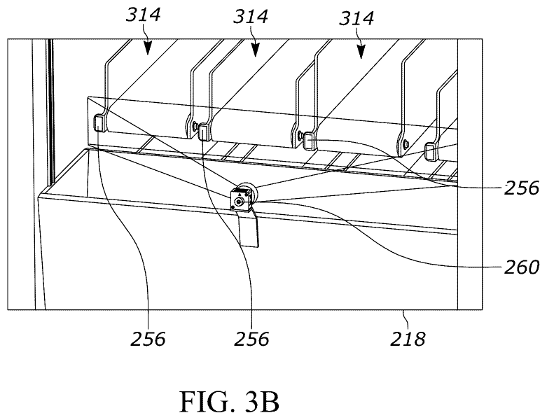

Referring now to FIGS. 3A and 3B, a portion of the vending machine 200 referenced in FIG. 2A is depicted and includes many of the same features as the vending machine 100 of FIG. 1. As a result, parts of the vending machine 200 that are the same as parts of the vending machine 100 include the same reference numbers increased by 100 and are not explained again in detail for the sake of brevity.

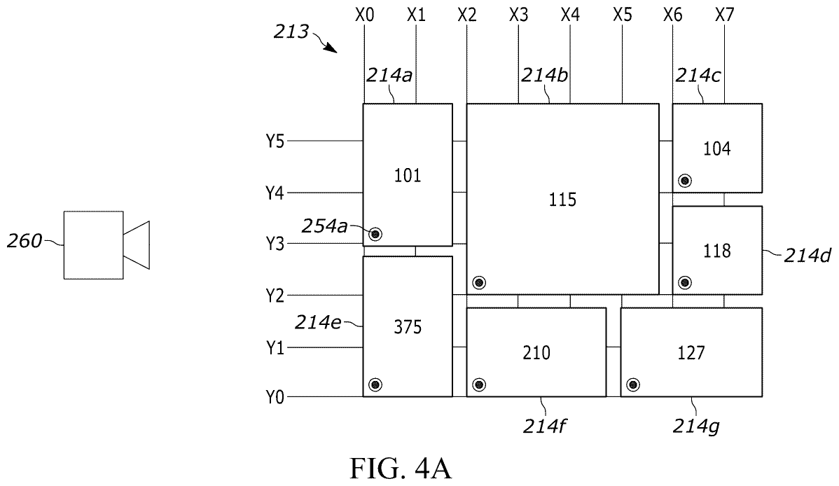

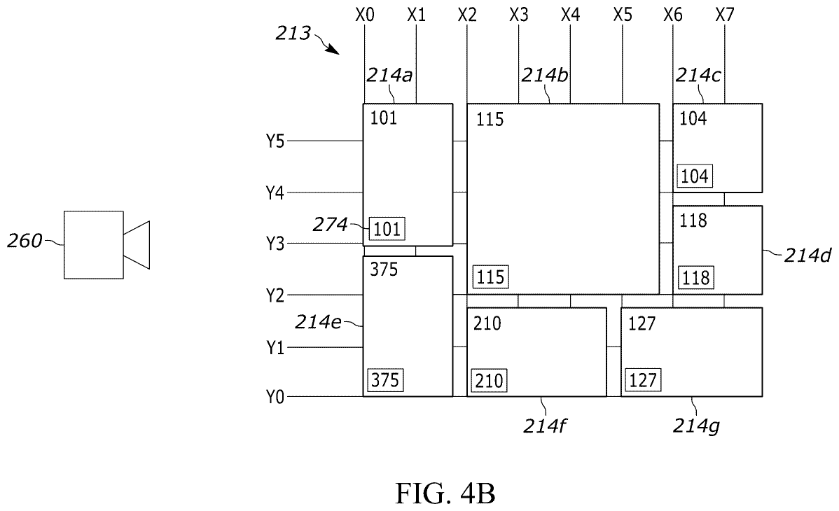

More specifically, and referring specifically to FIG. 3A, the vending machine 200 includes a housing 203 having a door 204 and a pair of side walls 205. The door 204 is disposed on a front area of the housing 203 and is in an open position in the configuration of the vending machine 200 provided in FIG. 3. The door 204 includes a dispensing slot 206 from which the customer may take one or more items 102 and a transparent portion 207 through which the customer can view items 102 disposed within the housing 203 of the vending machine 200 when the door is in a closed position, for example (see, e.g., FIG. 1). The vending machine 200 further includes a modular dispensing system 211, such as a bidirectional modular dispensing system that forms an X/Y grid 213 of positions (see, e.g., FIG. 4A), disposed within the housing 203, as explained more below, and a gantry 218 again to receive the items 102 dispensed by the dispensing module 214 and then carry the received items 102 to a dispensing slot 206.

Still referring to FIG. 3A, the vending machine 200 also includes at least one camera 260 mounted to the gantry 218 to monitor a plurality of dispensing modules 214 coupled to the modular dispensing system 211, for example. In this example, the camera 260 is coupled to a central, top portion of the gantry 218. In another example, multiple cameras may be used, such as one camera coupled to one side of the gantry 218, another camera coupled to the other side of the gantry 218, and yet another camera coupled to a central portion of the gantry 218, for example. It will be appreciated that still further multiple camera configurations and numbers of cameras may additionally and/or alternatively be used and still fall within the scope of the present disclosure.

Regardless of the configuration of the one or more cameras 260, the cameras 260 are capable of capturing image data across the entire X/Y grid 213. In some configurations, image data generated from one or more stationary cameras 260 can be combined to produce a set of image data that includes the entire X/Y grid 213. Additionally or alternatively, one or more cameras 260 mounted to the gantry 218 may be moved across the grid 213 such that sequential images captured by the one or more cameras 260 include image data representative of the entire X/Y grid 213.

As depicted in FIG. 3A, some dispensing modules disposed within the housing 203 of the vending machine 200 are larger than other dispensing modules. For example, one section of the modular dispensing system 211 includes a plurality of dispensing modules 214 having the same size. In addition, another section of the modular dispensing system 211 includes dispensing modules 314 of the plurality of dispensing modules that are larger than the dispensing modules 214, for example, and thus accommodate units of product having a greater width. A close-up view of some of the dispensing modules 314 of the plurality of dispensing modules that are larger than the dispensing modules 214 is depicted in FIG. 3B. The larger dispensing modules 314 are described more below.

It should be appreciated that after all of the dispensing modules 214, 314 are coupled to the modular dispensing system 211, the controller 202 is not aware of which specific dispensing module 214, 314 is coupled to each position in the modular dispensing system 211. Thus, the controller 202 may perform a registration process to determine the correspondence between the dispensing modules 214, 314 and a position in the grid 213 of the modular dispensing system 211. The controller 202 issues commands over the dispensing module control bus to cause the dispensing modules 214, 314 to turn on their indicator units 256, such as a light emitting diode (LED), one at a time.

Referring now to FIGS. 4A and 4B, two different registration approaches are described. In both figures, a plurality of dispensing modules 214 of varying X/Y sizes are coupled to the grid 213 of the modular dispensing system 211 in the same arrangement. In the illustrated embodiments, the grid 213 includes 6 possible vertical positions (Y0-Y5) and 8 possible horizontal positions (X0-X7). Of course, in other embodiments, the grid 213 may support any number of vertical and horizontal positions.

Starting with the approach shown in FIG. 4A, each of the dispensing modules 214 includes an indicator unit 256 (such as an LED) and stores a unique identifier. When a dispensing module 214 is coupled to the modular dispensing system 211, the controller 252 reports the identifier stored over the dispensing control bus. For example, the dispensing module 214a may generate and transmit a message indicating that dispensing module identifier 101 is coupled to the modular dispensing system 211. This process may continue as each of the dispensing modules 214a-g are coupled to modular dispensing system 211.

During this process, the controller 202 of the vending machine 200 monitors the dispensing control bus to generate a list of dispensing module identifiers corresponding to dispensing modules 214 coupled to the modular dispensing system 211. The controller 202 may then sequentially register the location of each of the dispensing modules 214 included in the list.

To register the location of a dispensing module 214, the controller 202 may generate and transmit commands over the dispensing control bus. For example, the controller 202 may generate and transmit a command that the dispensing module 214 having the identifier 101 activates its respective indicator system 254. In this example, the controller 252 of the dispensing module 214a detects the command and activates the indicator system 254a. The controller 202 then analyzes the image data generated by the one or more cameras 260 to identify the location of the dispensing module 214a and/or the indicator system 254a with respect to the grid 213. For example, the controller 202 may determine that the dispensing module is located at position {X0, Y3} corresponding to the position of the indicator unit 254a, position {X0, Y5} corresponding to the upper left position of the dispensing module 254a, or a plurality of positions {X0-X1, Y3-Y5} corresponding to the footprint of the dispensing module 254a with respect to the grid 213. In embodiments where the vending machine 200 includes a gantry 218, it may be preferable to associate the dispensing modules 214 with a position at which the gantry 218 is to be positioned when receiving a vended item (e.g., the X/Y position corresponding to a horizontal position at the center of the dispensing module 214 and a vertical position at the bottom of the dispensing module 214). The controller 202 then stores the correspondence between dispensing module identifier (101) and dispensing module position in a registry (e.g., the planogram 234). The controller 202 may repeat this process until the registry is updated with the position in the grid 213 for each detected dispensing module identifier.

In the approach illustrated in FIG. 4B, the dispensing modules 214 include a visible code 274 that encodes the dispensing module identifier. The code may be a QR code, a barcode, or other types marking that can encode a dispensing module identifier. Accordingly, rather than requiring the controller 202 to signal each dispensing module 214 to activate the respective indicator system 254, the controller 202 may analyze the image data generated by the one or more cameras to detect the presence of the codes 274 on dispensing modules 214 as they are coupled to the modular dispensing system 211. The controller 202 then identifies a position of the dispensing module 214 with respect to the grid 213 and decodes the code 274 to obtain an indication of the dispensing module identifier. The controller 202 may then update the registry to include the association between the grid position of the dispensing module 214 and the dispensing module identifier.

While the visible code approach may enable faster registration of the dispensing modules 214, this approach may not be possible to implement in all scenarios. For example, the image data produced by the one or more cameras 260 may not have sufficient resolution to be able to decode the code 274. In some embodiments, the total number of unique IDs for all dispensing modules 214 supported by a vending machine operator may be greater than the maximum number of unique encodings for the implemented encoding technology. Additionally, some dispensing modules 214 may already include the indication system 254 to support other functionality. Thus, in some situations it may still be preferred to perform the approach described with respect to FIG. 4A.

Regardless of the approach, after the controller 202 registers the correspondence between dispensing module identifiers and positions in the grid 213, the controller 202 is able to query the registry when issuing commands over the dispensing module control bus. For example, if the planogram 234 indicates that a cobb salad is to be positioned on a dispensing module 214, 314 in position {X4, Y5} of the grid 213, in response to detecting a command to vend the cobb salad, the controller 202 may query the registry to obtain the dispensing module identifier for the dispensing module 214, 314 at position {4,5} and transmit a vend command over the dispensing module control bus that includes the obtained dispensing module identifier. Similarly, the controller 202 may query the registry during an assisted restocking process to provide guidance as to which dispensing module 214 a product is to be stocked within the vending machine 200.

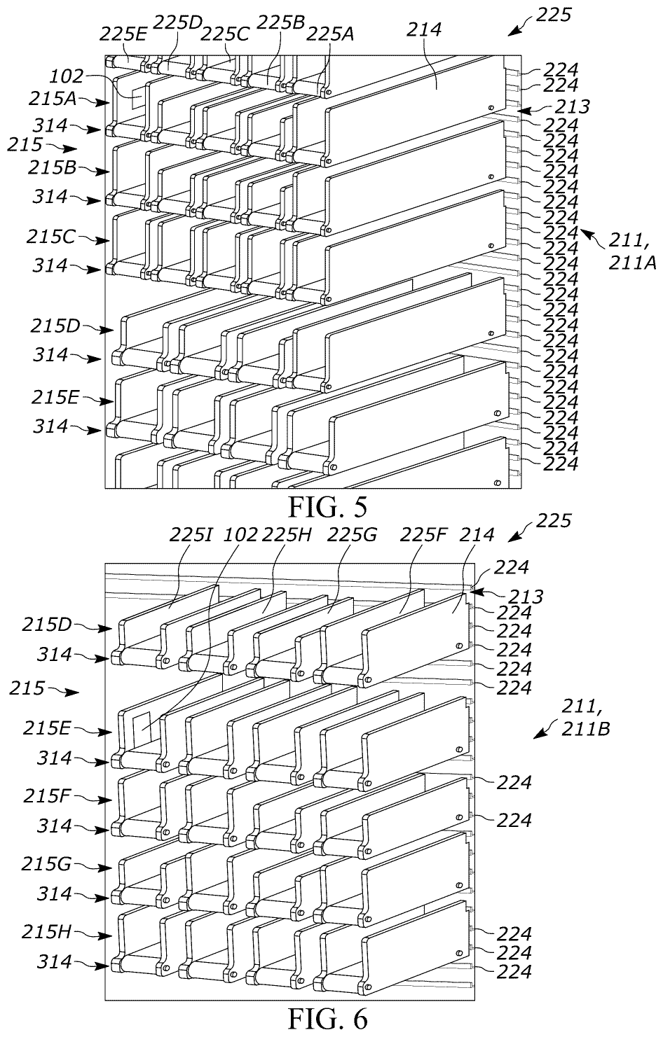

Referring now to FIGS. 5 and 6, portions of the modular dispensing system 211 of the vending machine 200 of FIG. 3 are depicted removed from the housing 203 of the vending machine 200. More specifically, a first portion 211A of the modular dispensing system 211 is depicted in FIG. 5, and a second portion 211B of the modular dispensing system 211 is depicted in FIG. 6. As depicted in each of the first and second portions 211A, 211B of the modular dispensing system 211 of FIGS. 5 and 6, the modular dispensing system 211 includes a grid 213 of mounting rails 224 configured to be secured to the housing 203, such as the rear wall 207 of the housing 203, and each mounting rail 224 has at least one X/Y position on the grid 213, as explained more below. The modular dispensing system 211 further includes a plurality of dispensing modules 214, 314 removably coupled to the mounting rails 224 of the grid 213 and capable of being arranged in a plurality of rows 215 and a plurality of columns 225 within the housing 203. At least one dispensing module 214, 314 is configured to receive the item 102 for purchase.

In the first portion 211A of the modular dispensing system 211 of FIG. 5, five rows 215A-215E of the plurality of rows 215 of dispensing modules 214, 314 for receiving the items 102 are depicted. In this example, the two lowermost rows 215D, 215E depicted include dispensing modules 314 larger in size than the three additional rows 215A-215C of dispensing modules 214 disposed above the two lowermost rows 215D, 215E. In addition, for the first three rows 215A-215C of the plurality of rows 215 of the dispensing modules 214 of FIG. 5, the plurality of dispensing modules 214 are arranged to include five columns 225A, 225B, 225C, 225D, and 225E of dispensing modules 214.

In the second portion 211B of the modular dispensing system 211 of FIG. 6, five rows 215D, 215E, 215F, 215G, and 215H of the plurality of rows 215 of dispensing modules 214 are depicted. In this example, the widths of the dispensing modules 314 in each of the rows 215D-215H is about the same for each row. In addition, for the five rows 215D-215H of the plurality of rows 215 of the dispensing modules 214 in this portion of the modular dispensing system 211, the plurality of dispensing modules 314 are arranged to plurality of columns 225. In this example, the plurality of columns 225 includes four columns 225F, 225G, 225H, and 225I of dispensing modules 214, 314 accommodating larger dispensing modules 314. More generally, at least one column of the plurality of columns 225 of dispensing modules 214, 314 is formed across at least a portion of the plurality of rows 215 of the grid 213 of mounting rails 224.

While FIGS. 5 and 6 depict this example configuration of the dispensing modules 214, 314 it will be appreciated that the modular dispensing system 211 of the present invention may include various other arrangements of dispensing modules 214, 314 coupled to the mounting rails 224, such that more or fewer rows of the plurality of rows 215 or more or fewer columns of the plurality of columns 225 may be arranged within the housing 203.

More specifically, each dispensing module 214, 314 of the plurality of dispensing modules 214, 314 is configured to be coupled to more than one mounting rail 224 of the grid 213 at multiple X/Y positions on the grid 213 of mounting rails 224. In this way, the modular dispensing system 211 may accommodate one or more various heights and widths of the items 102 for purchase to be disposed on one or more dispensing modules 214, 314.

It will be appreciated that the flexible characteristics of the modular dispensing system 211 of the present disclosure allow the dispensing modules 214, 314 to be coupled to any desired number of mounting rails 224 disposed at various, multiple X/Y positions on the grid 213 to accommodate different heights and widths of units 102 disposed on the dispensing modules 214, 314. Units for purchase 102 having a greater width than other units for purchase 102 may be disposed on two dispensing modules 214 and/or the larger dispensing modules 314 (described more below) and units 102 for purchase having a smaller width may be disposed on one dispensing module 214 and/or smaller dispensing modules 214, as depicted in FIGS. 5 and 6.

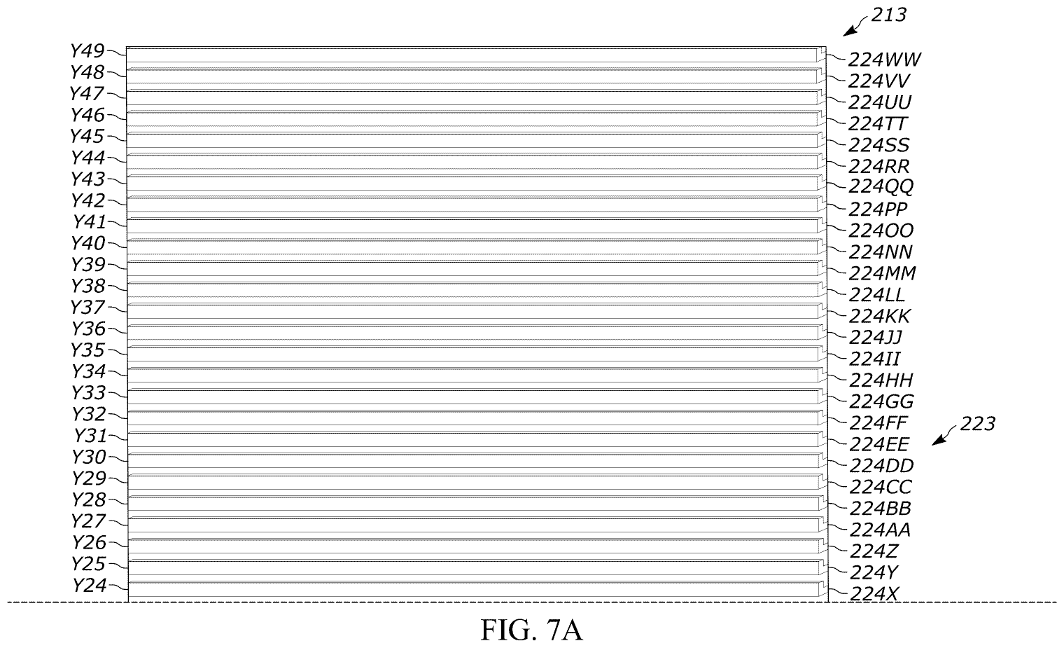

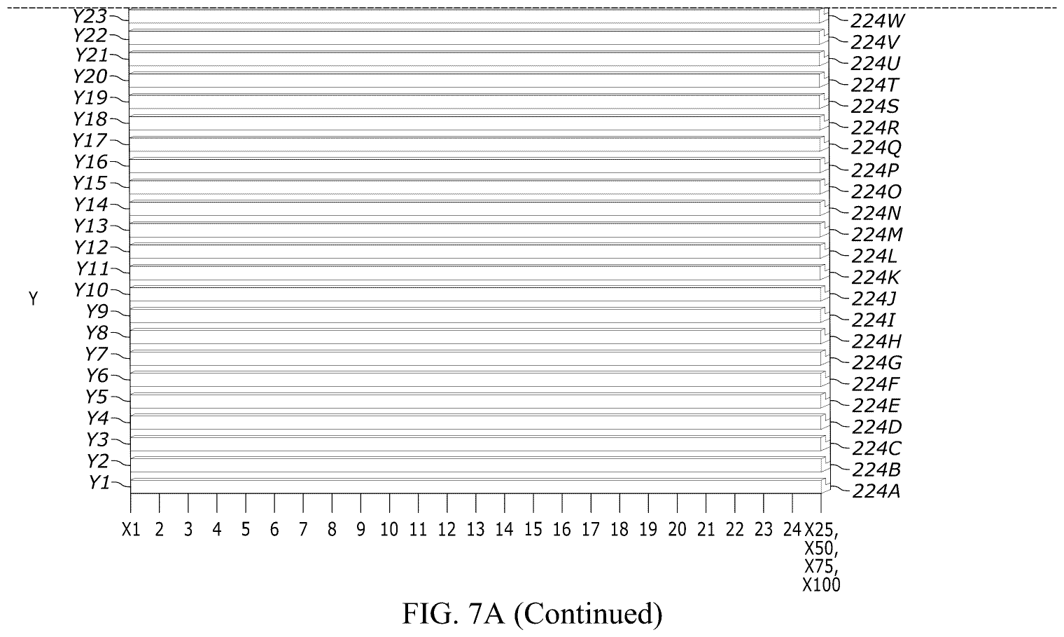

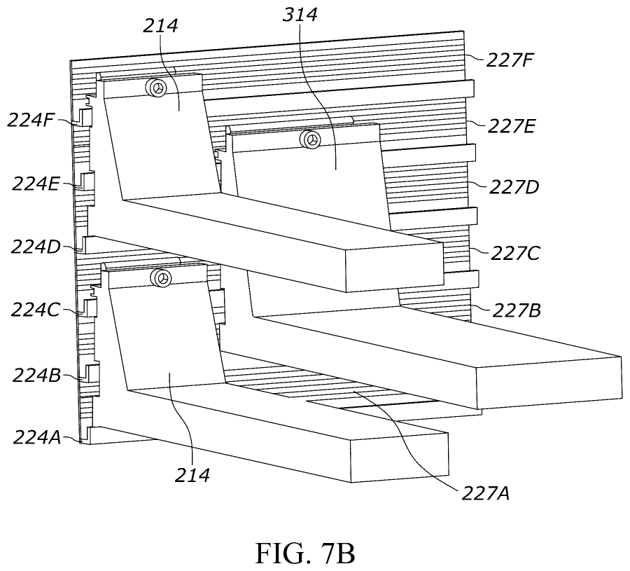

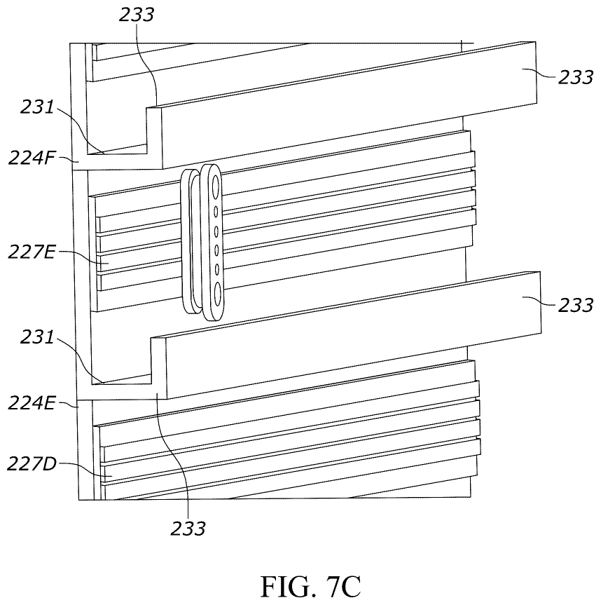

Referring now to FIG. 7A, the complete grid 213 of the modular dispensing system 211 of FIGS. 5 and 6 is depicted without any dispensing module 214 coupled to the mounting rails 224. More specifically, the grid 213 of the modular dispensing system 211 includes an Y axis having a plurality of Y coordinates corresponding to a number of mounting rails 224. The grid 213 also includes a X axis having a plurality of X coordinates corresponding to number of locations to which the plurality of dispensing modules 214 may be coupled to the one or more mounting rails 224, as described more below. In this example, the plurality of X coordinates includes coordinates X1-X25. However, it will be appreciated that the plurality of X coordinates of the grid 213 may alternatively include various other ranges of X coordinates, such as X1-X50, X1-X75, and X-100 and still fall within the scope of the present disclosure. Said another way, the number of X coordinates may be set on the grid 213 to correspond to various sizes of the dispensing modules 214 configured to be coupled to the mounting rails 224 to accommodate as many dispensing modules 224 and thus various sizes of units for purchase 102 that are disposed on the dispensing modules 224. In addition, in this example, the plurality of Y coordinates includes coordinates Y1-Y49. As will be appreciated, there may be fewer or more Y coordinates on the grid 213 and still fall within the scope of the present disclosure. Based on this X/Y coordinate system, each mounting rail 224A-224WW of the grid 213 includes at least one X/Y position on the grid 213, and each dispensing module 214 coupled to more than one mounting rail 224AA-224WW of the grid 213 is disposed at multiple X/Y positions on the grid 213 corresponding to the various X coordinates and the Y coordinates, as explained more below.

Still further, the grid 213 of mounting rails 224 includes a plurality of rows 223, and each row of mounting rails 224 is configured to receive one or more dispensing modules 214, 314 of the plurality of dispensing modules 214, 314. In addition, each dispensing module 214, 314 in each row of the plurality of rows 223 has multiple X/Y positions on the grid 213 of mounting rails 224, as also explained more below.

Referring now to FIG. 7B, a portion of the grid 213 of the mounting rails 224 of FIG. 7A with some dispensing modules 214, 314 coupled to the mounting rails 224 is depicted. Specifically, the grid 213 of mounting rails 224 includes the plurality of mounting rails 224 and a plurality of conductive strips 227. Each conductive strip 227, such as 227A-227F, of the plurality of conductive strips 227 is disposed along the width of the X-axis of the grid 213, like each mounting rail 224 of the grid 213. In addition, each conductive strip 227A-F is continuous along the width of the grid 213 and is disposed between the respective mounting rails 224. For example, and as depicted in the portion of the grid 213 of mounting rails 224 of FIG. 7B, the conductive strip 227E is disposed between mounting rails 224 F and 224E, another conductive strip 227D is disposed between mounting rails 224E and 224D, and another conductive strip 227C is disposed between mounting rails 224D and 224C. In a similar manner, another conductive strip 227B is disposed between mounting rails 224C and 224B, and still another conductive strip 227A is disposed between mounting rails 224B and 224A. Two dispensing modules 214 are coupled to multiple mounting rails 224D-224E and 224A-224C at multiple locations along the X-axis and the Y-axis of the grid 213 of mounting rails. Another larger dispensing module 314 (explained more below) is also coupled to the multiple mounting rails 224B-224E at X-axis coordinates different than the two smaller dispensing modules 214 adjacent to the dispensing module 314 and some of the same Y-axis coordinates. More detail is provided below relative to how the dispensing modules 214, 314 are coupled to multiple mounting rails 224.

Referring now to FIG. 7C, a portion of the grid 213 of mounting rails 224 of FIG. 7B is depicted, with another close-up view of the mounting rails 224F and 224E and the conductive strip 227E disposed therebetween. The mounting rails 224F and 224E are representative of the structure of each mounting rail 224 of the grid 213. Each mounting rail 224, and thus mounting rails 224F and 224E, includes a body 231 outwardly extending from the grid 213 and a mounting lip 233. In this example, the mounting lip 233 is upwardly extending from the body 231 of the mounting rail 224. However, the mounting lip 233 may also be in another configuration and still fall within the scope of the present disclosure. The mounting lips 233 of multiple mounting rails 224 are configured to engage at least one of a clamp, an arm or a body of a connecting member of the dispensing modules 214, 314, as also explained more below. In addition, and in one example, the conductive strips 227 allow for electrical connectivity at any location or position along the X-axis of the grid 213. In this example, the communication would be via RS-485 or similar, allowing multiple dispensing modules 214, 314 to communicate on the same signal bus, for example. So configured, the continuous strips 227, e.g., 227E, allow for a great amount of flexibility in the location and placement of the dispensing modules 214, 314 at any desired multiple X/Y positions on the grid 213 to minimize empty spaces along the grid 213 of mounting rails 224.

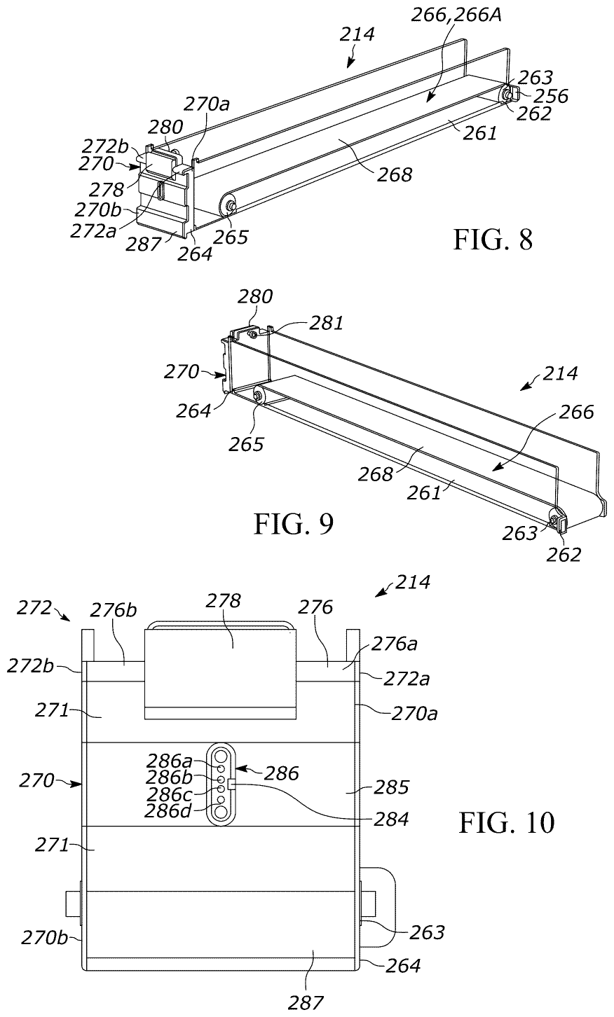

Referring now to FIGS. 8-10, a single dispensing module 214 is depicted, which is representative of each dispensing module 214 referred to herein. Specifically, each dispensing module 214 of the plurality of dispensing modules 215 includes a body 261 having a first end 262 and a second end 264. A dispensing mechanism 266 is disposed between the first and second ends 262, 264 for moving the item 102 for purchase from a first position on the dispensing mechanism 266 near the second end 264 of the body 261 to a second position at or near the first end 262 of the body 261 to discharge the item 102 from the dispensing module 214, for example. In one example, and as depicted, the dispensing mechanism 266 is a conveyor system 266A having a first roller 263 disposed at or near the first end 262 of the body 261, a second roller 265 disposed at or near the second end 264 of the body 261, and a conveyor belt 268 disposed around the first and second rollers 263, 265 on either side of the body 261. The dispensing module 214 also includes a connecting member 270 disposed at or near the second end 264 of the body 261. The connecting member 270 of the dispensing module 214 is configured to be coupled to more than one mounting rail 224, as described in more detail below. The conveyor belt 268 is configured to move around the rollers 263, 265 in a first direction or a second direction. In one example, the first direction is a direction toward the first end 262 of the body 261, and the second direction is a direction toward the second end 264 of the body 261.

As further depicted, the dispensing module 214 includes the indication unit 256 disposed near the first end 262 of the body 261. In the depicted embodiment, the indication unit 256 includes a light emitting diode (LED) disposed within a housing that supports the first roller 263. The housing includes an aperture via which the light emitted by the LED passes through to illuminate a region proximate to the first end 262. Alternatively, the LED may be disposed in other portions of the body 261 near the first end 262. While FIGS. 8 and 9 depict a single LED position on a side of the first end 262 of the body 261, in some embodiments, the indication unit 256 includes an additional LED on an opposite side of the first end 262. In alternate embodiments, the indication unit 256 includes a display screen affixed to a member extending from the first end 262 of the body 261.

As further depicted in FIGS. 8-10, the dispensing module 214 further includes the connecting member 270 disposed near or at the second end 264 of the body 261. The connecting member 270 includes a first end 270a and a second end 270b disposed opposite to the second end 270a. The first end 270a of the connecting member 270 includes a pair of projections 272 with a first projection 272a and a second projection 272b. A cylindrical member 276 includes a first end 276a in contact with the first projection 272a, and a second end 276b in contact with the second projection 272b.

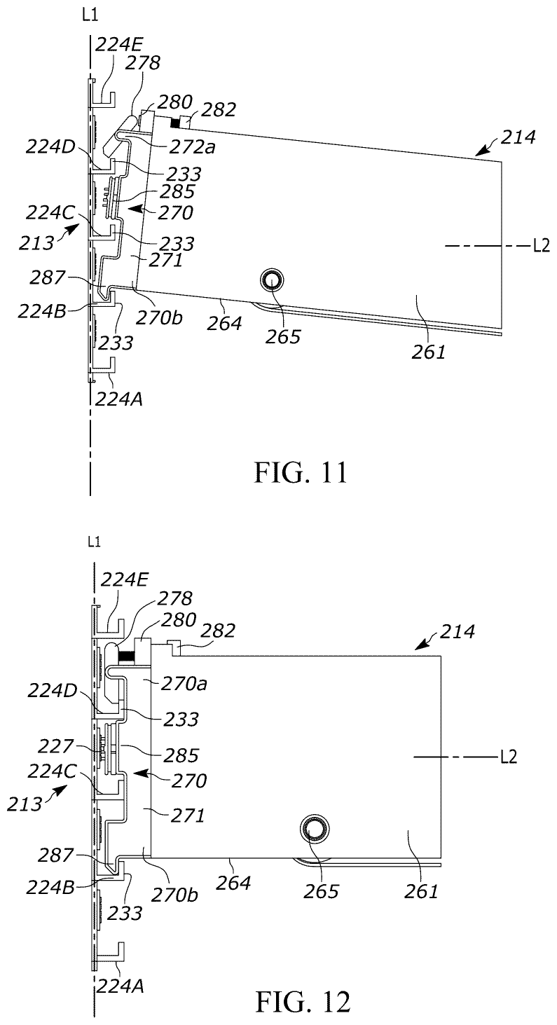

As depicted in FIG. 10, a clamp 278 is disposed between the first and second projections 272a, 272b and includes a bore (not depicted) for receiving the cylindrical member 276, such that the clamp 278 rotates about the cylindrical member 276. The top portion 270a of the connecting member 270 also includes a back plate 280 (FIG. 9) disposed adjacent to and behind the clamp 278 in one example. Said another way, the back plate 280 is disposed between the second roller 265 of the body 261 of the dispensing module 214 and the clamp 278. The back plate 280 includes an aperture 281 for receiving an actuating mechanism or actuator 282 (FIGS. 11, 12) configured to rotate and/or move the clamp 278 to contact at the mounting lip 233 of at least one mounting rail 224 to couple the dispensing module 214 to mounting rails 224 of the grid 213 of mounting rails of the modular dispensing system 211.

Still referring to FIG. 10, the connecting member 270 of the dispensing module 214 also includes an electrical connector 284 disposed in a central area 285 of the body 271 of the connecting member 270. In one example, the electrical connector 284 includes a plurality of pins 286 that are configured to contact 229 the conductive strips 227 disposed on the grid 213 of mounting rails between the mounting rails 224. So configured, when the dispensing module 214 is coupled to multiple mounting rails 224 of the grid 213, pins 286a, 286b, 286c, and 286d of the plurality of pins 286 contact the conductive strip 227 to establish a communicative coupling, such as an electrical connection, between the dispensing module 214, 314 and the grid 213, for example. In one example, the central portion 285 of the connecting member 270 outwardly projects from a body 271 of the connecting member 270.

The connecting member 270 also includes an arm 287 disposed at the second end 270b of the connecting member 270 and downwardly extending from the body 271 of the connecting member 270. As explained more below, the arm 287 is configured to contact and be coupled to at least one other mounting rail 224 of the grid 213 (different from the mounting rail 224 to which the clamp 278 is in contact) when the dispensing module 214 is coupled to more than one mounting rails 224.

Referring now to FIGS. 11 and 12, a side view of the dispensing module 214 in an unlatched position relative to the mounting rails 224 of the grid 213 is depicted in FIG. 11. In addition, a side view of the dispensing module 214 in a latched position relative to the mounting rail 224 of the grid 213 of the modular dispensing system is depicted in FIG. 12. The grid 213 of the mounting rails 224 includes a longitudinal axis L1, and the body 261 of the dispensing module 214 also includes a longitudinal axis L2. The dispensing module 214 is coupled to several and/or multiple mounting rails 224 of the grid 213 via the connecting member 270. Specifically, the arm 287 disposed at the second end 270b of the connecting member 270 of the dispensing module 214 is first placed over the mounting lip 233 of the mounting rail 224 at a first mounting rail, such as the mounting rail 224B in FIG. 11. The actuator or actuating mechanism 282 is then actuated to move and/or rotate the clamp 278 disposed at the first end 270a of the connecting member 270 from an angled or first position in which the clamp 278 is not in contact with any portion of any mounting rail 224, as depicted in FIG. 11, to a position in which the clamp 278 is in contact with the mounting lip 233 of a second mounting rail 224, such as the mounting rail 224D, as depicted in FIGS. 11 and 12. As a result of the actuating movement, the body 261 is also rotated in a counter-clockwise direction relative to the longitudinal axis L1 of the grid 213 until the central portion 285 of the connecting member 270 is disposed between two mounting rails 224 of the grid 213 of mounting rails, such as the mounting rails 224C and 224D of FIG. 12, and aligned with the continuous electrical strip 227 of the grid 213. In this latched position, the clamp 278 is then disposed substantially parallel to the longitudinal axis L1 of the grid 213, as depicted in FIG. 12. In addition, the longitudinal axis L2 of the at least one dispensing module 214, 314 is substantially perpendicular to the longitudinal axis LI of the grid 213 of the mounting rails 224 when the at least one dispensing module 214, 314 is coupled to more than one mounting rail 224 of the grid 213 of mounting rails 224, e.g., in the latched position.

As further depicted in FIG. 12, for example, each dispensing module 214, 314 is also configured to at least overlap or engage one or more mounting rails 224 of the grid 213 of mounting rails 224 when the dispensing module 214, 314 is coupled to more than one mounting rail 224 of the grid 213 of mounting rails 224. In one example, the dispensing module 214 of FIG. 12 engages the mounting lip 233 of the mounting rails 224D and 224B and overlaps the mounting rail 224C when in the latched position and coupled to more than one mounting rail of the grid 213 of mounting rails 224.

More specifically, and in one example, the actuating mechanism 282 is threaded screw that is rotated to contact and then move the clamp 278 from the angled position to a substantially parallel position relative to the longitudinal axis L1 of the grid 213. The clamp 278 is then latched to the mounting lip 233 of the desired mounting rail 224 of the grid 213 to achieve the latched position of the dispensing module 214 relative to the grid 213 of mounting rails 224.

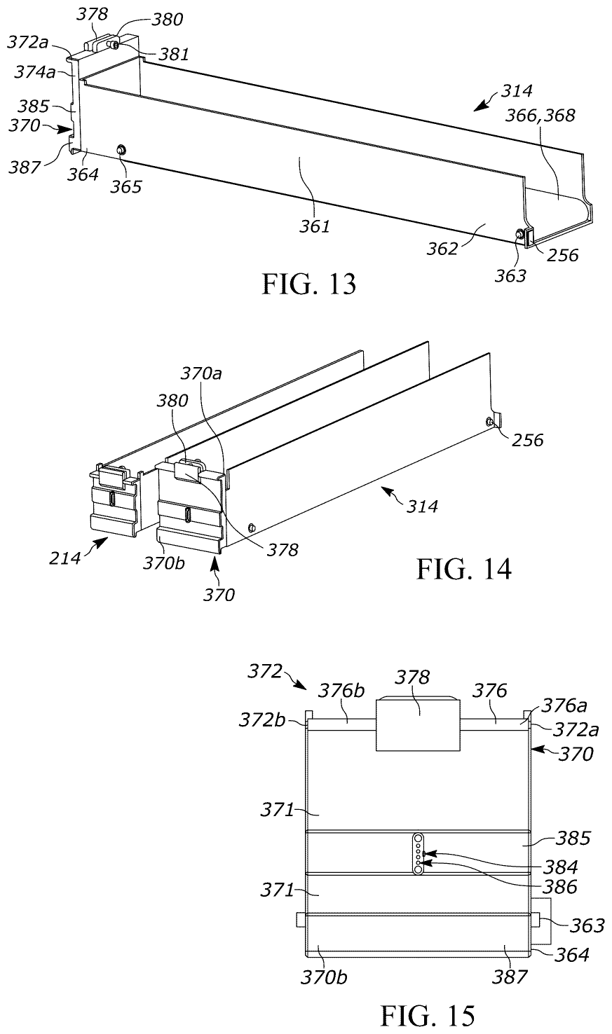

Referring now to FIGS. 13-17, the other larger dispensing module 314 (referred to above) of the modular dispensing system 211 of the present disclosure is depicted. The dispensing module 314 is essentially the same as the dispensing module 214 described above except the dispensing module 314 is larger than the dispensing module 214 and thus able to accommodate larger units for purchase 102 for the vending machine 100, 200. Parts of the dispensing module 314 that are the same as parts of the dispensing module 214 include reference numbers 100 more than the reference numbers of the dispensing module 214.

Referring now to FIGS. 13-15, the single dispensing module 314 is depicted. Specifically, the dispensing module 314 may be a part of the plurality of dispensing modules 215 and includes a body 361 having a first end 362 and a second end 364. A dispensing mechanism 366 is disposed between the first and second ends 362, 364 for moving the item 102 for purchase from a first position on the dispensing mechanism 366 near the second end 364 of the body 361 to a second position at or near the first end 362 of the body 361, just like the dispensing module 214 described above. In one example, the dispensing mechanism 366 is a conveyor system having a first roller 363 disposed at or near the first end 362 of the body 361, a second roller 365 disposed at or near the second end 364 of the body 361, and a conveyor belt 368 disposed around the first and second rollers 363, 365 on either side of the body 361. The dispensing module 314 also includes a connecting member 370 disposed at or near the second end 364 of the body 361. The connecting member 370 of the dispensing module 314 is configured to be coupled to more than one mounting rail 324, as described in more detail below. The conveyor belt 368 is configured to move around the rollers 363, 365 in a first direction or a second direction. In one example, the first direction is a direction toward the first end 362 of the body, and the second direction is a direction toward the second end 364 of the body 360.

As further depicted, the dispensing module 314 includes the indication unit 256 disposed near the first end 362 of the body 360. The indication unit 256 is the same indication unit 256 of the dispensing module 314 described above and is not described here again for the sake of brevity.

The connecting member 370 is disposed near or at the second end 364 of the body 360. The connecting member 370 includes a first end 370a and a second end 370b disposed opposite to the second end 370a. The first end 370a of the connecting member 370 includes a pair of projections 372 with a first projection 372a and a second projection 372b. A cylindrical member 376 includes a first end 376a in contact with the first projection 372a, and a second end 376b in contact with the second projection 372b.

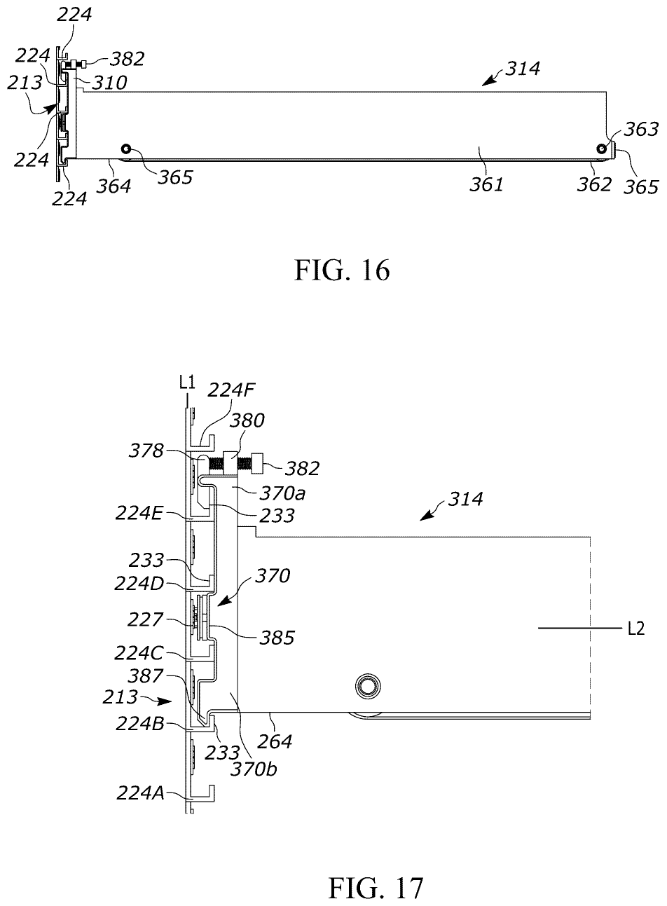

As also depicted in FIGS. 13-15, a clamp 378 is disposed between the first and second projections 372a, 372b and includes a bore (not depicted) for receiving the cylindrical member 376, such that the clamp 378 rotates about the cylindrical member 376. The top portion 370a of the connecting member 370 also includes a back plate 380 disposed adjacent to the clamp 378 and behind the clamp 378 in one example. Said another way, the back plate 380 is disposed between the second roller 365 of the body 361 of the dispensing module 314 and the clamp 378. The back plate 380 includes an aperture 381 for receiving an actuating mechanism or actuator 382 (FIGS. 16, 17) configured to rotate and/or move the clamp 378 to couple the dispensing module 314 to mounting rails 324 of the grid 213 of the modular dispensing system 211.

Referring now to FIG. 15, the connecting member 370 of the dispensing module 314 also includes an electrical connector 384 disposed in a central area 385 of the connecting member 370. In one example, the electrical connector 384 includes a plurality of pins 386 that are configured to contact the continuous conductive strips 227 disposed on the grid 213 between the mounting rails 224. So configured, when the dispensing module 314 is coupled to multiple mounting rails 224 of the grid 213, the pins 386 contact the continuous conductive strip 227 to establish an electrical connection between the dispensing module 314 and the grid 213, for example. In one example, the central portion 385 of the connecting member 370 outwardly projects from a body 371 of the connecting member 370.

The connecting member 370 also includes an arm 387 disposed at the second end 370b of the connecting member 370 and downwardly extending from the body 371 of the connecting member 370. As explained more below, the arm 387 is configured to contact and be coupled to at least one mounting rail 224 of the grid 213 to help couple the dispensing module 314 to the grid of mounting rails 224.

Referring now to FIGS. 16 and 17, a side view of the dispensing module 314 in a latched position relative to the mounting rails 224 of the grid 213 is depicted in FIG. 16, and a close-up view of the connecting member 370 of the dispensing module 314 of FIG. 16 is depicted in FIG. 17. As depicted in FIG. 17, the grid 213 of the mounting rails 224 includes a longitudinal axis L1, and the body 361 of the dispensing module 314 also includes a longitudinal axis L2. The dispensing module 314 is coupled to particular mounting rails 224 of the grid 213 via the connecting member 370. Specifically, to achieve the latched position, the arm 387 disposed at the second end 370b of the connecting member 370 of the dispensing module 314 is first placed over the mounting lip 233 of a first mounting rail 224, such as the mounting rail 224B of FIG. 17. The actuating mechanism 382 is then actuated to move and/or rotate the clamp 378 disposed at the first end 370a of the connecting member 370 from an angled position in which the clamp 378 is not in contact with any portion of any mounting rail 224 to a position in which the clamp 378 is in contact with the mounting lip 233 of a second mounting rail 224 of the grid 213, such as the mounting rail 224E, as depicted in FIGS. 16 and 17. Upon this actuation, the body 361 is also simultaneously rotated in a counter-clockwise direction relative to the longitudinal axis L1 of the grid 213 until the central portion 385 of the connecting member 270 is disposed between two mounting rails 224 of the grid 213, such as the mounting rails 224D and 224DC, and aligned with the continuous electrical strip 227 of the grid 213. In this latched position, the connecting member 370 is disposed substantially parallel to the longitudinal axis L1 of the grid 213 and the pins 386 of the electrical connector 384 mate with the contacts 229 of the conductive strip 227. In addition, inserting the pins 386 of the electrical connector 384 into the contacts 229 of the conductive strip 227 establishes a communicative coupling between the controller 202 of the vending machine 200 and the controller 252 of the dispensing module 314.

In this example, the actuating mechanism 382 is a threaded screw that is rotated to contact and then move and/or rotate the clamp 378 from an angled position to a position in which the clamp 378 latches to the mounting lip 233 of the desired mounting rail 224 of the grid 213, as depicted FIG. 17. As a result, the connecting member 370 and thus the dispensing module 314 are then coupled to the grid 213 of mounting rails 224. While the actuating mechanism 382 in this example is a threaded screw, it will be appreciated that various other actuating mechanisms 382, such as a spring-loaded member, may alternatively and/or additionally be used and still fall within the scope of the present disclosure.

According to aspects, and so configured, a three-point contact is produced by the arm 287, 387 of the dispensing module 214, 314 (pulling the dispensing module to the left, e.g., in FIGS. 11, 12), the mounting rails 224C (pushing the dispensing module 214, 314 to the right), and the clamp 278 and mounting rail 224D together (pulling the dispensing module 214, 314 to the left). A distance between the mounting rail 224C and the mounting rail 224D allows the clamp 278 to react to the bending moment produced by the weight of the dispensing tray and product disposed thereon.

It will be appreciated that the foregoing vending machines and modules dispensing systems may operate according to one or more of the following methods. Specifically, the method may include latching the 287, 387 arm disposed at one end of the at least one dispensing module 214, 314 to the mounting lip 233 of a first mounting rail 224, 224B. The method may also include moving, via the actuator 282, 382, the clamp 278, 378 disposed at another end of the at least one dispensing module 214, 314 into contact with the mounting lip 233 of a second mounting rail 224, 224D to couple the dispensing module 214, 314 to the first and second mounting rails 224B, 224D. In this way, the body 261, 361 of the dispensing module 214, 314 is disposed approximately perpendicular to a longitudinal axis L1 of the grid 213 of mounting rails 224.

In addition, the method may also include identifying, via at least one of at least one processor of the vending machine 100, 200 or the camera 260 disposed in the housing 203 of the vending machine 200, at least one X/Y position of the dispensing module 214, 314 based on at least one X/Y position of the first and second mounting rails 224, 224B, 224D of the grid 213 of mounting rails to which the dispensing module 214, 314 is coupled. In another example, moving, via the actuator 282, 382, the clamp 278, 378 disposed at another end of the at least one dispensing module 214, 314 into contact with the mounting lip 233 of a second mounting rail 224, 224D to couple the dispensing module 214, 314 to the first and second mounting rails 224B, 224D may comprise rotating the body 261, 361 of the at least one dispensing module 214, 314 in a counterclockwise direction relative to the longitudinal axis L1 of the grid 213 of mounting rails to allow the clamp 278, 378 of the dispensing module 214, 314 to engage the mounting lip 233 of the second mounting rail 224, 224D. In yet another example and/or additionally and/or alternatively, moving, via the actuator 282, 382, the clamp 278, 378 disposed at another end of the at least one dispensing module 214, 314 into contact with the mounting lip 233 of a second mounting rail 224, 224D to couple the dispensing module 214, 314 to the first and second mounting rails 224B, 224D may comprise coupling the electrical connector 284, 384 of the dispensing module 214, 314 to the conductive strip 227 of the grid 213 of mounting rails.

In view of the foregoing, it will be appreciated that vending machine and related systems and methods described include several advantages. For example, the new modular dispensing system and related methods have many more mounting locations with dispensing modules 214, 314 able to span multiple mounting locations on the grid 213 of the mounting rails both horizontally and vertically. This allows for dense packing of randomly sized items for sale, for example, improving overall spacing issues within the vending machine. The new dispensing modules 214, 314 include simplified extrusion profile and positive clamping engagement with the mounting rails 224 to prevent rattling. At least in view of these features, the new modular dispensing system of the present disclosure has greater flexibility in accommodating various sizes of items for sale desired to be disposed in the vending machine compared to conventional modular dispensing systems, for example. Further, both the simplified mechanical connection and electrical connection of the dispensing modules to the mounting rails provides overall more efficient manufacturing and assembly of the modular dispensing system and vending machine overall.

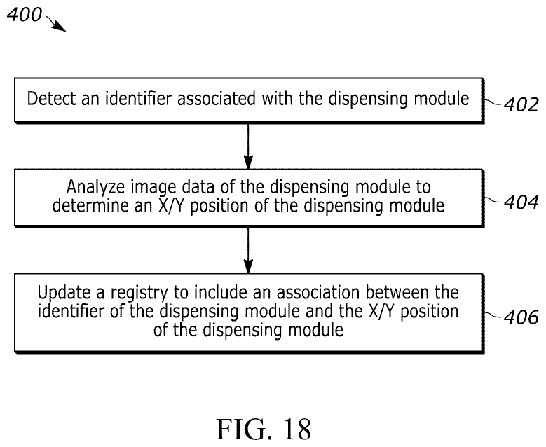

FIG. 18 illustrates an example method 400 for registering a dispensing module (such as a dispensing module 214, 314) of a modular dispensing system (such as the modular dispensing system 211) for a vending machine (such as the vending machines 100 or 200). The modular dispensing system includes a grid of mounting rails (such as the mounting rails 224, 324). The method 400 may be implemented by a controller (such as the controller 202) of the vending machine.

The method 400 begins at block 402 when the controller detects an identifier associated with the dispensing module. In some embodiments, the controller detects the identifier within a message written to a dispensing module control bus. In other embodiments, the controller may analyze image data generated by one or more cameras (such as the one or more cameras 260) to identify a code (such as the code 274) associated with the dispensing module and decode the identified code to obtain the identifier.

At block 404, the controller analyzes image data of the dispensing module to determine an X/Y position of the dispensing module. In embodiments where the identifier is detected via the dispensing module control bus, the controller may first identify a position of the dispensing module in the image data. Accordingly, the controller may generate a message that includes the detect identifier instructing the dispensing module to activate an indicator system (such as an indicator system 254) and identify the dispensing module in the image data based upon image data indicative of the dispensing module activating the indicator system. The controller may then determine the X/Y position of the dispensing module identified in the image data. To determine the X/Y position, the controller determine an X/Y position at which a gantry (such as the gantries 118, 218) of the vending machine is to be positioned to receive an item loaded into the dispensing module.

At block 406, the controller updates a registry to include an association between the identifier of the dispensing module and the X/Y position of the dispensing module. In some embodiments, the registry is included in a planogram stored in a memory (such as the memory 230) of the vending machine. The controller may be configured to repeat the method 400 for any number of dispensing modules coupled to the module dispensing system.

### Additional Considerations

As mentioned above, aspects of the systems and methods described herein are controlled by one or more controllers. The one or more controllers may be adapted to run a variety of application programs, access and store data, including accessing and storing data in the associated databases, and enable one or more interactions as described herein. Typically, the controller is implemented by one or more programmable data processing devices. The hardware elements, operating systems, and programming languages of such devices are conventional in nature, and it is presumed that those skilled in the art are adequately familiar therewith.

The one or more controllers may also include one or more input/output interfaces for communications with one or more processing systems. Although not shown, one or more such interfaces may enable communications via a network, e.g., to enable sending and receiving instructions electronically. The communication links may be wired or wireless.

The one or more controllers may further include appropriate input/output ports for interconnection with one or more output mechanisms (e.g., monitors, printers, touchscreens, motion-sensing input devices, etc.) and one or more input mechanisms (e.g., keyboards, mice, voice, touchscreens, bioelectric devices, magnetic readers, RFID readers, barcode readers, motion-sensing input devices, etc.) serving as one or more user interfaces for the controller. For example, the one or more controllers may include a graphics subsystem to drive the output mechanism. The links of the peripherals to the system may be wired connections or use wireless communications.

Although summarized above as a PC-type implementation, those skilled in the art will recognize that the one or more controllers also encompass systems such as host computers, cloud computers, servers, workstations, network terminals, and the like. Further one or more controllers may be embodied in a device, such as a mobile electronic device, like a smartphone or tablet computer. In fact, the use of the term controller is intended to represent a broad category of components that are well known in the art.

Hence aspects of the systems and methods provided herein encompass hardware and software for controlling the relevant functions. Software may take the form of code or executable instructions for causing a controller or other programmable equipment to perform the relevant steps, where the code or instructions are carried by or otherwise embodied in a medium readable by the controller or other machine. Instructions or code for implementing such operations may be in the form of computer instruction in any form (e.g., source code, object code, interpreted code, etc.) stored in or carried by any tangible readable medium.

As used herein, terms such as computer or machine “readable medium” refer to any medium that participates in providing instructions to a processor for execution. Such a medium may take many forms. Non-volatile storage media include, for example, optical or magnetic disks, such as any of the storage devices in any computer(s) shown in the drawings. Volatile storage media include dynamic memory, such as the memory of such a computer platform. Common forms of computer-readable media therefore include for example: a floppy disk, a flexible disk, hard disk, magnetic tape, any other magnetic medium, a CD-ROM, DVD, any other optical medium, punch cards, paper tape, any other physical medium with patterns of holes, a RAM, a PROM and EPROM, a FLASH-EPROM, any other memory chip or cartridge, or any other medium from which a controller can read programming code and/or data. Many of these forms of computer readable media may be involved in carrying one or more sequences of one or more instructions to a processor for execution.

It should be noted that various changes and modifications to the embodiments described herein will be apparent to those skilled in the art. Such changes and modifications may be made without departing from the spirit and scope of the present invention and without diminishing its attendant advantages. For example, various embodiments of the systems and methods may be provided based on various combinations of the features and functions from the subject matter provided herein.

What is claimed is:

1. A method of coupling a dispensing module of a modular dispensing system for a vending machine to more than one mounting rail of the modular dispensing system, the modular dispensing system including a grid of mounting rails and a plurality of dispensing modules, the method comprising:
latching an arm disposed at one end of at least one dispensing module to a mounting lip of a first mounting rail; and
moving, via an actuator, a clamp disposed at another end of the at least one dispensing module into contact with a mounting lip of a second mounting rail to couple the dispensing module to the first and second mounting rails, such that the body of the dispensing module is disposed approximately perpendicular to a longitudinal axis of a grid of mounting rails.

2. The method of claim 1, further comprising identifying, via at least one of at least one processor of the vending machine or a camera disposed in the housing of the vending machine, at least one X/Y position of the dispensing module based on at least one X/Y position of the first and second mounting rails of the grid to which the dispensing module is coupled.

3. The method of claim 1, wherein moving, via an actuator, a clamp disposed at another end of the at least one dispensing module into contact with a mounting lip of a second mounting rail to couple the dispensing module to the first and second mounting rails further comprises rotating the body of the at least one dispensing module in a counterclockwise direction relative to a longitudinal axis of the grid of mounting rails to allow the clamp of the dispensing module to engage the mounting lip of the second mounting rail.

4. The method of claim 1, wherein moving, via an actuator, a clamp disposed at another end of the at least one dispensing module into contact with a mounting lip of a second mounting rail to couple the dispensing module to the first and second mounting rails further comprises coupling an electrical connector of the dispensing module to a conductive strip of the grid of mounting rails disposed between the first and second mounting rails.

5. A modular dispensing system for a vending machine, the modular dispensing system comprising:
a grid of mounting rails, each mounting rail having at least one X/Y position on the grid; and
a plurality of dispensing modules removably coupled to the mounting rails of the grid, at least one dispensing module configured to receive an item for purchase,
where each dispensing module of the plurality of dispensing modules is configured to be coupled to more than one mounting rail of the grid at multiple X/Y positions of the grid of mounting rails to accommodate one or more heights of the item for purchase.

6. The system of claim 5, wherein the grid of mounting rails includes a plurality of rows, each row configured to receive one or more dispensing modules of the plurality of dispensing modules, and each dispensing module in each row having multiple X/Y positions on the grid.

7. The system of claim 5, wherein the plurality of dispensing modules is configured to form a plurality of columns when coupled to the mounting rails, and at least one column of the plurality of columns of dispensing modules is formed across at least a portion of the plurality of rows of the plurality of rails.

8. The system of claim 5, wherein the grid of mounting rails includes a plurality of conductive strips, each conductive strip disposed between mounting rails of the grid and continuous along a width of the grid of mounting rails, the conductive strips configured to contact a portion of the dispensing module to establish a communicative coupling between the grid of mounting rails and the dispensing module.

9. The system of claim 5, wherein each dispensing module of the plurality of dispensing modules includes a body having a first end and a second end, a dispensing mechanism disposed between the first and second ends for moving the item for purchase from a first position on the dispensing mechanism near a second end of the body to a second position at or near the first end of the body to discharge the item from the dispensing module.

10. The system of claim 5, wherein the dispensing module further including a connecting member disposed near the second end of the body and having a pair of projections extending therefrom, a clamp disposed between the pair of projections and configured to contact a mounting lip of the mounting rail when the dispensing module is coupled to the mounting rails, and an arm downwardly extending at an end of the connecting member opposite to the pair of projections, the arm configured to contact another mounting lip of another mounting rail of the grid when the dispensing module is coupled to more than one mounting rail.

11. The system of claim 5, wherein each mounting rail includes a body extending from the grid of mounting rails along a width of the grid of mounting rails and a mounting lip, the mounting lip of multiple mounting rails configured to engage at least one of a clamp, an arm, or a body of the connecting member of the dispensing module when the dispensing module is coupled to the mounting rails.

12. A vending machine comprising:
a housing; and
the modular dispensing system of claim 5.

13. The vending machine of claim 12, further comprising a gantry disposed within the housing and having a camera, the camera configured to monitor the plurality of dispensing modules and register a location of each dispensing module coupled to the grid of mounting rails.

14. The vending machine of claim 12, wherein the dispensing mechanism is a conveyor system having a first roller disposed at the first end of the body, a second roller disposed at a second end of the body, and a conveyor belt disposed around the first and second rollers on either side of the body, the conveyor belt configured to move around the rollers in a first direction or a second direction, the first direction toward the first end of the body and the second direction away from the first end of the body.

15. The vending machines of claim 12, wherein each dispensing module includes a motor, a controller, and at least one sensor, the controller providing a communication link with a central processing unit of the vending machine when the dispensing module is coupled to more than one mounting rail of the grid of mounting rails, enabling one or more of the controller or a camera disposed in the housing to identify the X/Y positions of the dispensing module based on the X/Y positions of the mounting rails to which the dispensing module is coupled.

16. A method of registering a dispensing module of a modular dispensing system for a vending machine, the modular dispensing system including a grid of mounting rails, the method comprising:
detecting, by a vending machine controller, an identifier associated with the dispensing module;
analyzing, by the vending machine controller, image data of the dispensing module to determine an X/Y position of the dispensing module; and
updating, by the vending machine controller, a registry to include an association between the identifier of the dispensing module and the X/Y position of the dispensing module.

17. The method of claim 16, wherein detecting the identifier comprises:
detecting, by the vending machine controller, the identifier within a message written to a dispensing module control bus.

18. The method of claim 16, wherein determining the X/Y position of the dispensing module comprises:
generating, by the vending machine controller, a message instructing the dispensing module to activate an indicator system, wherein the message includes the detected identifier;
identifying, by the vending machine controller, the dispensing module in the image data based upon image data indicative of the dispensing module activating the indicator system; and
determining, by the vending machine controller, the X/Y position of the dispensing module identified in the image data.

19. The method of claim 16, wherein detecting the identifier comprises:
analyzing, by the vending machine controller, the image data from a camera to identify a code associated with the dispensing module; and
decoding, by the vending machine controller, the identified code to obtain the identifier.

20. The method of claim 16, wherein determining the X/Y position comprises:
determining, by the vending machine controller, an X/Y position at which a gantry of the vending machine is to be positioned to receive an item loaded into the dispensing module.

21. The method of claim 16, wherein the registry included in a planogram stored in a memory of the vending machine.
